(19) United States
(12) Patent Application Publication
(10) Pub. No.: US 2006/0131840 A1
(43) Pub. Date: Jun. 22, 2006

(54) Children's stroller

(76) Inventor: Joshua L. Donay, Miamisburg, OH (US)

Correspondence Address: TAFT, STETTINIUS & HOLLISTER LLP, SUITE 1800, 425 WALNUT STREET, CINCINNATI, OH, 45202-3957, US

(21) Appl. No.: 11/018,553

(22) Filed: Dec. 21, 2004

(51) Int. Cl. B62B 7/00

(52) U.S. Cl. 280/642

(57) ABSTRACT

The invention is directed to strollers for children and, more specifically, to various features of a stroller providing increased comfort and functionality over prior art strollers. The exemplary stroller of the present invention includes a napper bar including a removable tray insert that is adapted to be attached and detached to facilitate cleaning of the tray area, without having to reposition the napper bar. A further exemplary feature of the invention includes a customizable child receiver. In an even further exemplary embodiment, the child receiver includes a first piece hingedly mounted to a second piece, hingedly mounted to a third piece. In this manner, the pieces may be reconfigured to provide a seating position with an upright back support, or a relatively flat lying position where the back support is parallel to a seat portion. Another exemplary feature of the invention includes a single action folding mechanism operative to facilitate folding of the stroller into a more compact unit. The single action mechanism includes a thumb lock operative to inhibit substantial actuation of a trigger to inhibit folding of the stroller. In this manner, accidental contact with the trigger alone is not operative to collapse the stroller when the thumb lock is engaged.

### BACKGROUND

1. Field of the Invention

The present invention is directed to strollers for children and, more specifically, to various features of a stroller providing increased comfort and functionality over prior art strollers.

2. Background of the Invention

In recent years, many developments have been made with respect to strollers. In particular, the folding features and maneuverability of strollers have been improved and strollers have been developed for use while jogging or in-line skating, over rugged terrain and through snow and sand.

### SUMMARY OF THE INVENTION

The present invention is directed to strollers for children and, more specifically, to various features of a stroller providing increased comfort and functionality over prior art strollers. An exemplary stroller in accordance with the present invention includes a napper bar including a removable tray insert adapted to be attached and detached to facilitate cleaning of the tray area, without repositioning the napper bar or stroller. A further exemplary feature of the invention includes a customizable child receiver. In an exemplary embodiment, the child receiver includes a first piece hingedly mounted to a second piece, hingedly mounted to a third piece. In this manner, the pieces may be reconfigured to provide a seating position with an upright back support, or a relatively flat lying position where the back support is parallel to a seat portion. Another exemplary feature of the invention includes a single action folding mechanism operative to facilitate folding of the stroller into a more compact unit. The single action mechanism includes a thumb lock operative to inhibit substantial actuation of a trigger to allow folding of the stroller. In this manner, accidental contact with the trigger alone is not operative to collapse the stroller when the thumb lock is engaged. It is to be understood that this summary is not intended to recite all aspects of the present invention and, therefore, other novel features may become apparent and reference is had to the following discussion of exemplary embodiments for an understanding of the scope of the present invention.

### BRIEF DESCRIPTION OF THE DRAWINGS

FIG. 1 is a front perspective view of an exemplary stroller in accordance with the present invention;

FIG. 2 is a left side view of an exemplary console and handle for use with the present invention;

FIG. 3 is a cross sectional view of an exemplary trigger mechanism in a locked position and housed within the handle of FIG. 2;

FIG. 4 is a cross sectional view of the exemplary trigger mechanism in a first intermediate position and housed within the handle of FIG. 2;

FIG. 5 is a cross sectional view of the exemplary trigger mechanism in a second intermediate position and housed within the handle of FIG. 2;

FIG. 6 is a cross sectional view of the exemplary trigger mechanism in a fully acutated position and housed within the handle of FIG. 2;

FIG. 7 is a cross sectional view of an exemplary frame folding mechanism for a stroller in accordance with the present invention, shown in a locked position;

FIG. 8 is a cross sectional view of the exemplary frame folding mechanism of FIG. 7 at a first intermediate position;

FIG. 9 is a cross sectional view of the exemplary frame folding mechanism of FIG. 7 at a second intermediate position;

FIG. 10 is a cross sectional view of the exemplary frame folding mechanism of FIG. 7 at a third intermediate position;

FIG. 11 is an isolated rear view of an exemplary adjustable backrest in a locked position in accordance with the present invention;

FIG. 12 is an isolated rear view of the exemplary adjustable backrest of FIG. 11 in an unlocked position in accordance with the present invention;

FIG. 13 is an exploded side view of an isolated segment of the exemplary backrest of FIGS. 11 and 12;

FIG. 14 is an elevated perspective view of an exemplary napper bar in accordance with the present invention; and

FIG. 15 is an exploded view of the exemplary napper bar of FIG. 14.

### DETAILED DESCRIPTION

The exemplary embodiments of the present invention are described and illustrated below to encompass children's strollers. Of course, it will be apparent to those of ordinary skill in the art that the preferred embodiments discussed below are exemplary in nature and may be reconfigured without departing from the scope of the present invention. However, for clarity and precision, the exemplary embodiments as discussed below may include optional features that one of ordinary skill should recognize as not being a requisite to fall within the scope of the present invention.

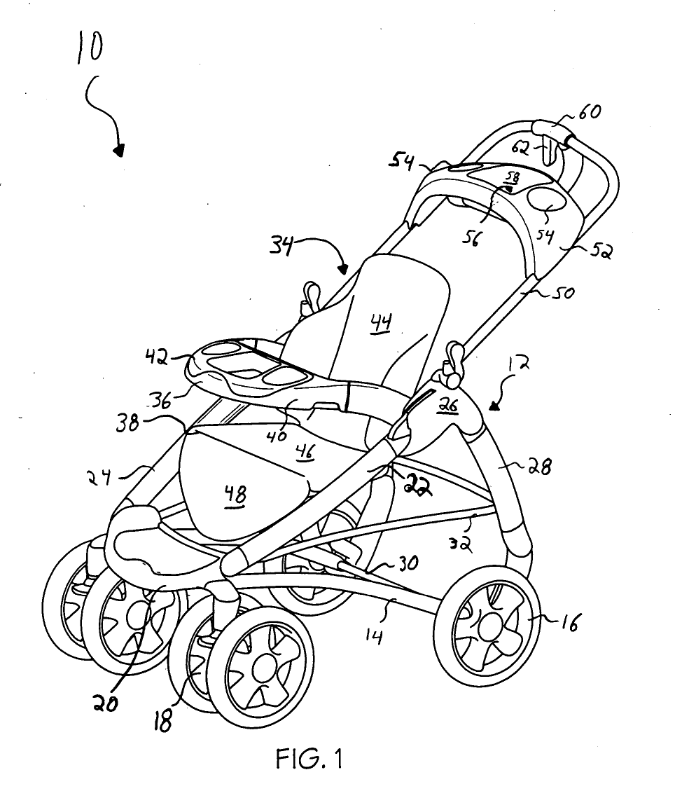

Referencing FIG. 1, an exemplary stroller 10 in accordance with the present invention includes a foldable frame 12. The foldable frame 12 includes a left side support 14 mounted at a first end to a left rear wheel assembly 16, and mounted at a second end to a left front wheel assembly 18. A cross member 20 is mounted to the left front wheel assembly 18 and a right front wheel assembly 22. The cross member 20 is also mounted to a left side angled support 22 and a right side angled support 24. Each angled support 22, 24 is mounted to a respective connector 26 that includes a release mechanism operative to lock and unlock the position of the frame members with respect to one another as will be discussed below. Each connector 26 is mounted to a respective vertical support 28 that is mounted to a rear wheel assembly 16. An axel 30 extends between the rear wheel assemblies 16 and a U-shaped support 32. The U-shaped support is shaped to have fabric material attached thereto to provide a compressible storage area.

The stroller 10 also includes a child receiving area 34 that includes a napper bar 36 and a platform 38. The napper bar 36 is mounted to respective connectors 26 and extends in a U-shaped manner in front of a child seated on the platform 38. The napper bar includes a repositionable arm 40 and a removable tray 42 removably mounted to the repositionable arm 40. As will be discussed in further detail below, full frontal access to a child seated on the platform 38 is available by simply disengaging one side of the arm 40 and rotating the disengaged side. The platform 38 includes three segments that cooperate to provide a backrest 44, a seat 46, and a leg guard 48. The backrest 44 and the leg guard 48 are pivotally mounted to the seat 46 and may be repositioned with respect to the seat. In an exemplary seated orientation, the backrest 44 is upright and perpendicular with respect to the seat 46, while the leg guard 48 faces downward and is perpendicular with respect to the seat 46.

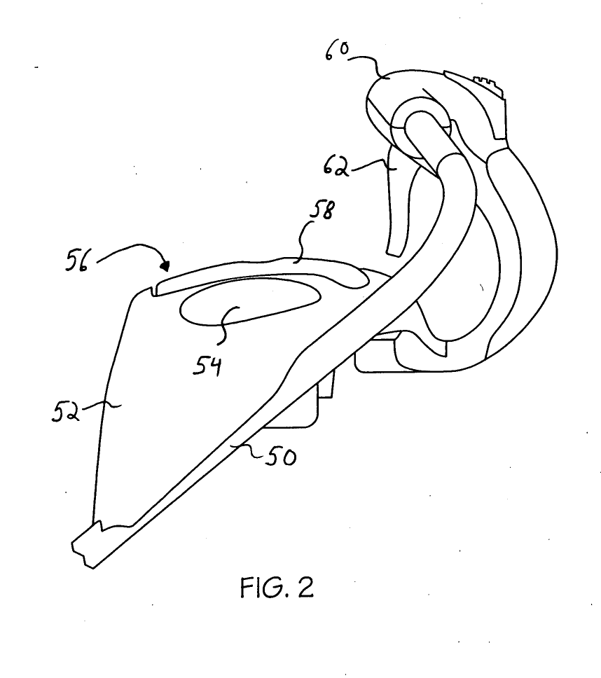

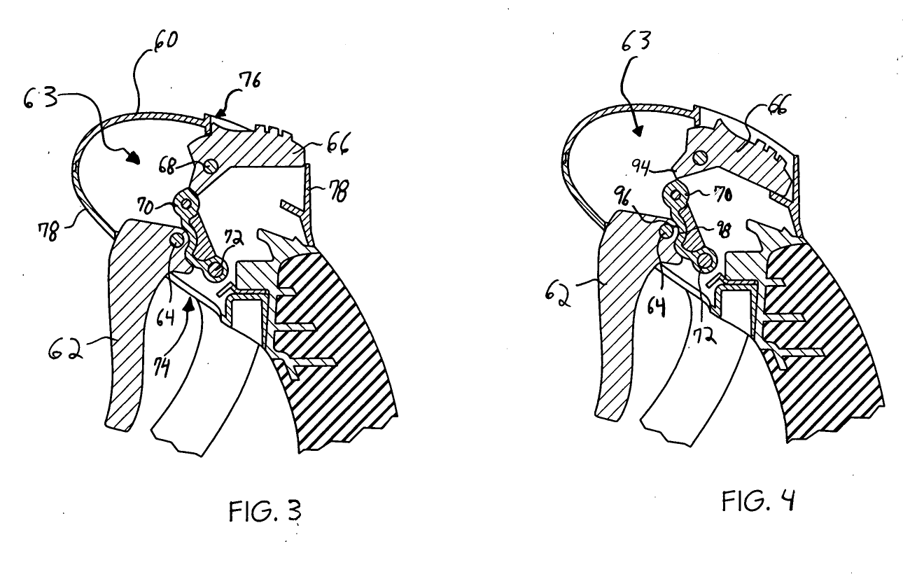

Referencing FIGS. 1 and 2, the stroller 10 also includes a contoured handlebar 50 adapted for gripping by a person operating the stroller 10. The handlebar is mounted to each connector 26 and includes a console 52 having drink holders 54 and a compartment 56 for holding loose items such as, without limitation, car keys, beverages, and snacks. The compartment includes a pivotally mounted cover 58 operative to provide selective access to the interior of the compartment 56. An apex of the handlebar 50 includes a T-shaped grip 60 that extends in an arcuate manner and mounts to the rear of the console 52. The grip 60 at least partially houses a trigger 62 and an associated mechanism 63 (see FIGS. 3-6) for selectively actuating a release mechanism of the stroller 10 enabling the stroller to be repositioned from an unfolded to a folded state.

Referencing FIGS. 3-6, the mechanism 63 includes the trigger 62 pivotally mounted about a pivot pin 64, a thumb lock 66 pivotally mounted about a pivot pin 68, and a trigger lever 70 pivotally mounted about a pivot pin 72. Two openings 74, 76 within the housing 78 provide access to the interior of the grip 60. The first opening 74 is pierced by the trigger 60 and provides for rotational movement of the trigger between the positions shown in FIGS. 3 and 6. The second opening 76 provides user access to the thumb lock 66 that is biased in the loaded position (see FIG. 3). A pair of connection lines (not shown) are mounted opposite the pivoting end of the trigger lever 70 and are channeled through the handlebar 50 leading to respective connectors 26 (see FIG. 1) that enable folding and unfolding of the stroller 10.

Referencing FIGS. 7-10, an internal mechanism 82 within each connector 26 is operative to lock and unlock the relative position of each angled support 22, 24 with respect to each vertical support (not shown). The mechanism 82 includes a biased catch pin 84 coupled to one of the connection lines.

As shown in FIG. 7, a notch 86 within the angled support 22, 24 is adapted to receive the catch pin 84 and inhibit rotation of the angled support, about a pivot pin 88, with respect to the vertical support. The position of the mechanism 82 as shown in FIG. 7 is indicative of the orientation of the stroller 10 as shown in FIG. 1. In order to facilitate rotation of the angled support 22, 24 about the pivot pin 88, the trigger 70 is actuated (see FIGS. 5 and 6) and pulls on the connection lines, thereby overcoming the bias of the catch pin 84 and pulling the catch pin from the notch 86. A cavity 90 formed within the connector provides a recess sufficient for the pin 84 to be seated therein and enabling the notch 86 to pass thereby during rotation of the supports 22, 24. After the notch 86 rotates in a clockwise manner beyond the catch pin 84, the trigger 70 may be released to allow the bias of the catch pin 84 to reposition the catch pin against an exterior surface 92 of the angled support 22, 24 (see FIG. 8). Further clockwise rotation of the angled supports 22, 24 moves the notch 86 beyond the catch pin 84 and facilitates folding of the stroller 10 (compare FIGS. 8, 9, and 10).

Referring to FIGS. 7-10, the stroller 10 may be repositioned from a folded position to its unfolded position (see FIG. 1) by rotating the angled support 22, 24 about the pivot pin 88 (see FIGS. 8-10) in a counterclockwise manner so that the catch pin 84 is seated within the notch 86. The seating of the catch pin 84 occurs when the notch 86 passes beyond the catch pin 84 and the biased nature of the pin forces the pin into engagement with the notch 86 and inhibits clockwise rotation of the angled support 22, 24 about the pivot pin 88.

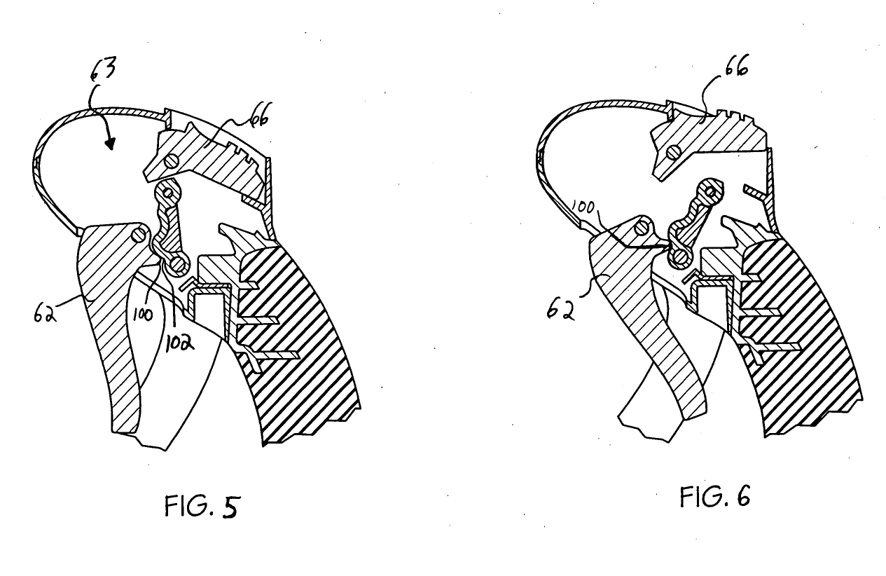

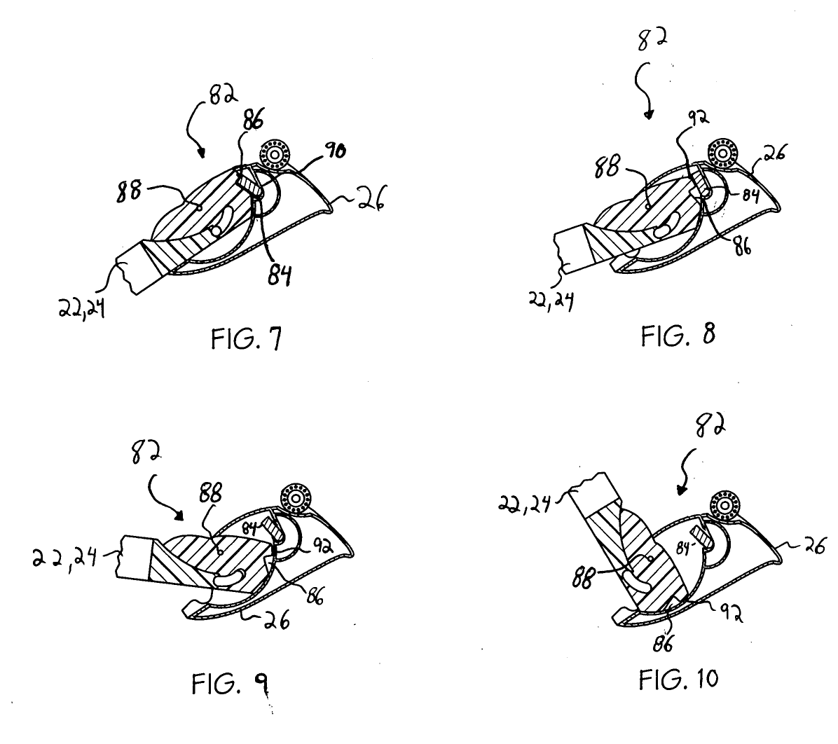

Referring again to FIGS. 3-6, in order to reposition the stroller 10 from an unfolded position to a folded position, the trigger lever 70 is rotated about the pivot pin 72 in a clockwise manner. While in the mechanism 63 is in the locked position (see FIG. 3), the thumb lock 66 is biased in a cocked orientation so that the stop 94 is adjacent to the opposing end of the trigger lever 70 and operative to inhibit rotation of the trigger lever about the pivot pin 72. If a user desires to fold the stroller 10, the thumb lock 66 is depressed to overcome the bias (“decock”) and reposition the stop 94 out of the line of travel of the trigger lever 70 (see FIG. 4). After the stop 94 is out of the line of travel of the trigger lever 70, the trigger 62 can be pivoted in a counterclockwise manner about the pivot pin 64.

The trigger 62 includes an S-shaped profile 96 that engages a corresponding camming surface 98 of the trigger lever 70 so that rotation of the trigger 62 is operative to result in rotation of the trigger lever 70 about the pivot pin 72. It should be noted that the trigger lever 70 is biased in the locked position (see FIG. 3), so that when the thumb lock 66 is decocked, rotation of the trigger lever 70 does not occur without a corresponding movement of the trigger 62. Counterclockwise rotation of the trigger 62 is operative to overcome the bias of the trigger lever 70, and provides for clockwise rotation of the trigger lever. This counterclockwise rotation of the trigger 62 displaces the connection lines and is operative to overcome the bias associated with the catch pin 84 (see FIGS. 7-10) to enable folding of the stroller 10.

As shown in FIGS. 5 and 6, further counterclockwise rotation of the trigger 62 results in further clockwise rotation between the S-shaped profile 96 and the camming surface 98 so that the tip 100 of the profile 96 fits within a cavity 102 formed within the camming surface 98. This counterclockwise rotation of the trigger 62 is operative to displace the trigger lever 70 to one of its final stages of rotation (see FIG. 6). After the trigger lever 70 clears the line of travel of the thumb lock 66, the biased nature of the thumb locks pivots the thumb lock back to the cocked orientation (see FIG. 6).

In order to reposition the stroller 10 from the folded position to the unfolded position, the user simply grabs the handlebar 50 and pulls upward (see FIG. 1). This upward pulling action results in the connection lines being drawn taught and operative to reposition the trigger lever 70 in a counterclockwise manner. When the trigger lever 70 reaches the rotational position as shown in FIG. 5, the pulling action on the connection lines is operative to overcome the bias of the trigger lock 64 to pivot the trigger lock to the decocked position, enabling the trigger lever to pass thereby. After the opposing end of the trigger lever 70 passes beyond the stop 94, the biased nature of the trigger lock 64 pivots to retain the trigger lever in the locked position (see FIG. 3).

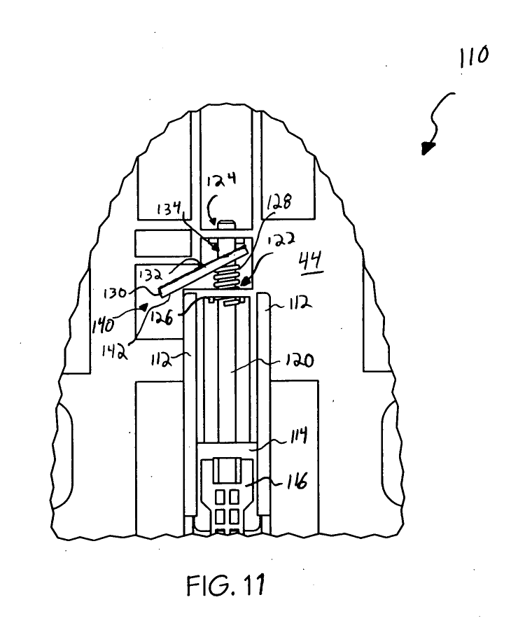

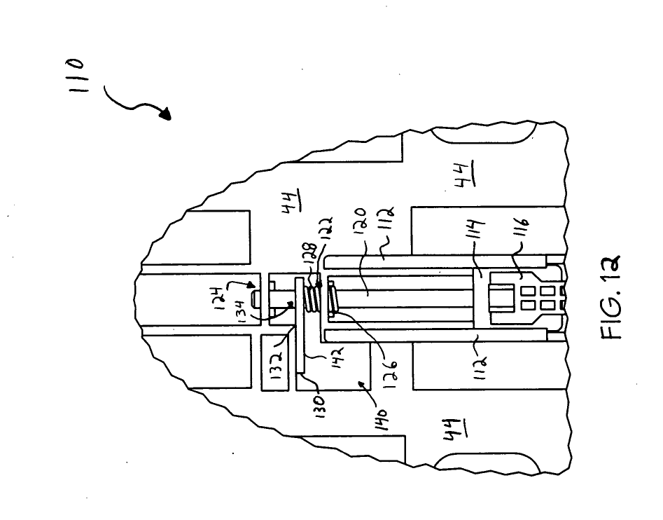

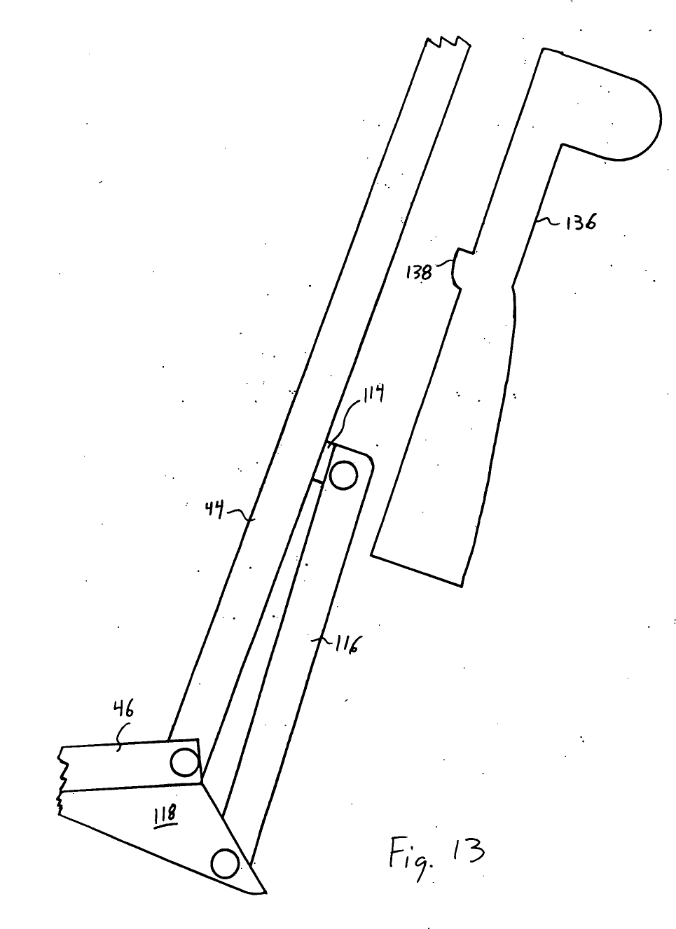

Referring to FIGS. 1 and 11-13, the stroller 10 includes an adjustable backrest 44. On the rear of the backrest 44, a repositionable mechanism 110 is provided that is operative to enable repositioning of the backrest 44 with respect to the seat 46. The mechanism 110 includes a slide track 112 along which a base member 114 slides. A stabilizer arm 116 is pivotally mounted at a first end to the base member 114 and pivotally mounted at a second end to a horizontal member 118 extending from underneath the seat 46. A rod 120 is mounted to the base member 114 and pierces two openings 122, 124 within the rear of the backrest 44. The first opening 122 includes a catch 126 operative to inhibit a spring 128 circumferentially oriented with respect to the rod 120 from passing therepast in the direction toward the slide track 112. The spring 128 biases a retainer bar 130 against an L-shaped wall 132 to selectively inhibit movement of the rod 120 through a hole 134 of the retainer bar 130 (see FIG. 11). The hole is large enough to allow the rod 120 to pass therethrough when the retainer bar 130 is positioned in a generally horizontal manner (see FIG. 12). The mechanism 110 is partially concealed by a repositionable cover 136 slidably mounted to the backrest 44. The cover 136 includes a projection 138 adapted to selectively engage the retainer bar 130 to enable repositioning of the backrest 44 with respect to the seat 46.

In operation, the projection 138 of the repositionable cover 136 is located within a cavity 140 occupied by the retainer bar 130. To reposition the backrest 44 with respect to the seat 46, the repositionable cover 136 is vertically repositioned so that the projection 138 engages a bottom surface of the exposed end 142 of the retainer bar. Continued upward force upon the cover 136 provides upward force on the projection 138 and thereby pushes against the bottom surface of the exposed end 142 of the retainer bar 130. If the upward force is sufficient to overcome the spring bias on the bar 130, the bar is pivoted on the corner of the L-shaped wall 132 and compresses the spring 128 between the bottom surface of the bar and the catch 126. FIG. 12 shows the orientation of the bar 130 when the projection 138 is forced upward to overcome the bias of the spring 128. When the bar 130 is pivoted, the rod 120 is released from a frictional brake established between the rod 120 and the hole 134, enabling the base member 114 to vertically slide within the slide track 112. The base member 114 may be vertically repositioned to vary the angular position of the backrest 44 with respect to the seat 46. For example, when the base member 114 is repositioned toward the first opening 122, the backrest 44 pivots toward a perpendicular orientation with respect to the seat 46, while movement of the base member 114 away from the first opening 122 is operative to pivot the backrest 44 away from the seat 46 toward a parallel orientation with respect to the seat 46. Whenever the desired orientation between the backrest 44 and the seat 46 is reached, the upward pressure on the cover 136 is discontinued. The absence of an upward force on the bottom surface of the bar 130 enables the bias of the spring 128 to force the hole 134 of the bar 130 to pivot (actually the bar is pivoted by the spring) upward and be positioned at an angled orientation that inhibits vertical movement of the rod 120 through the hole 134. This process may be repeated to provide for various angled orientations of the backrest 44 with respect to the seat 46.

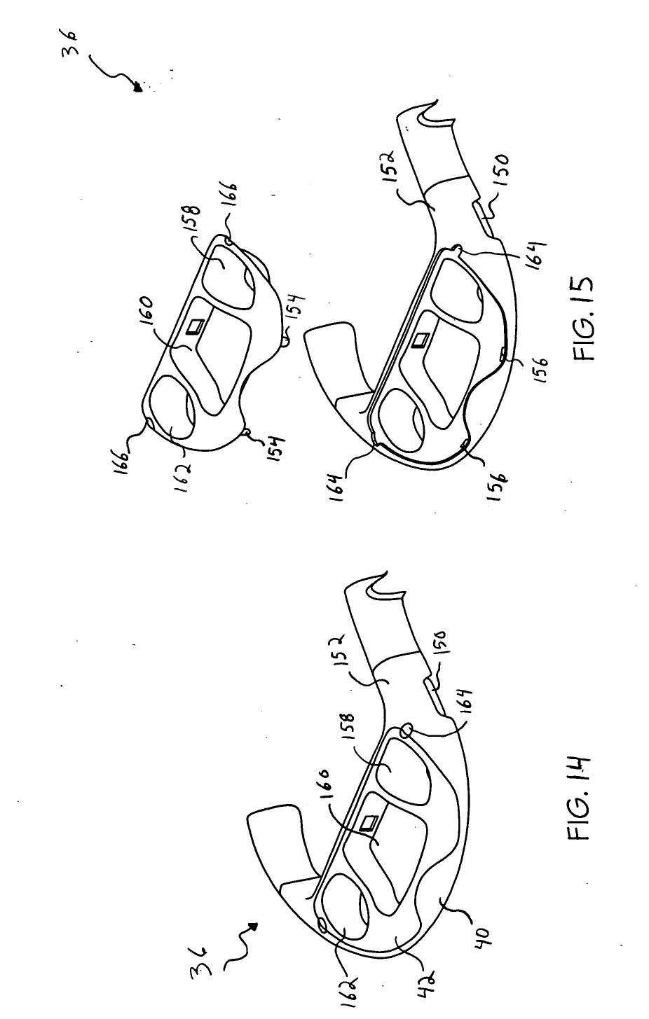

Referencing FIGS. 1, 14, and 15, the repositionable arm 40 of the napper bar 36 includes a pivoting member (not shown) and a biased release 150 enabling a user to apply a force to overcome the bias of the release and detach one side 152 of the arm from the retainer bar. After the bias of the release 150 as been overcome, the arm 40 may be pivoted counterclockwise (greater than 90 degrees) enabling full frontal access to a child seated within the stroller 10.

The repositionable arm 40 is also contoured to receive the removable tray 42. The tray 42 includes detents 154 that are adapted to interface with openings 156 within the arm 40 to selectively mount the tray to the arm. In exemplary form, the tray 42 includes three holding areas 158, 160, 162 that may respectively hold a beverage, a snack food, and a toy. Two peripheral depressions 164 associated with the arm 40 are generally aligned with two corresponding recesses 166 associated with the tray. The depressions 164 and recesses 166 are shaped to enable a user to more easily dislodge the tray 42 from the arm 40. The removable tray 42 allows for easy cleaning by a user thereof.

It is to be understood that the above exemplary embodiment components may be fabricated from various materials such as, without limitation, plastics, metals, and composites.

Following from the above description and invention summaries, it should be apparent to those of ordinary skill in the art that, while the methods and apparatuses herein described constitute exemplary embodiments of the present invention, the invention contained herein is not limited to this precise embodiment and that changes may be made to such embodiments without departing from the scope of the invention as defined by the claims. Additionally, it is to be understood that the invention is defined by the claims and it is not intended that any limitations or elements describing the exemplary embodiments set forth herein are to be incorporated into the interpretation of any claim element unless such limitation or element is explicitly stated. Likewise, it is to be understood that it is not necessary to meet any or all of the identified advantages or objects of the invention disclosed herein in order to fall within the scope of any claims, since the invention is defined by the claims and since inherent and/or unforeseen advantages of the present invention may exist even though they may not have been explicitly discussed herein.

What is claimed is:

1. An adjustable backrest for a stroller, the backrest comprising:
a back support pivotally mounted to a support structure of a stroller, the back support being angularly pivotable with respect to a seat portion of the support structure of the stroller;
a bracing arm repositionably mounted to the back support and the support structure of the stroller, the repositionable arm being vertically repositionable with respect to the back support; and
a latch operative to maintain the orientation of the back support with respect to the support structure in a locked position, and operative to enable repositioning of the back support with respect to the support structure in an unlocked position.

2. The adjustable backrest of claim 1, wherein:
the bracing arm is slidably repositionable with respect the back support and pivotally repositionable with respect to the support structure of the stroller; and
the latch includes a repositionable handle operative to selectively orient the latch in at least one of the locked position and the unlocked position.

3. The adjustable backrest of claim 2, wherein:
the bracing arm includes a sliding component and a primary component;
the sliding component is slidably repositionable within a groove of the back support;
the sliding component is pivotally mounted to the primary component; and
the primary component is pivotally mounted to the support structure of the stroller.

4. The adjustable backrest of claim 3, wherein:
the latch includes a lever adapted to engage the sliding component in the locked position; and
the handle is adapted to reposition the lever and enable movement between the sliding component and the lever in the unlocked position.

5. The backrest of claim 4, wherein:
the lever includes an orifice adapted to be pierced by at least a portion of the sliding component; and
an orientation between the orifice and the portion of the sliding component is changed when the latch is repositioned from the unlocked position to the locked position.

6. The backrest of claim 5, wherein:
the orientation of a plane parallel to the orifice is perpendicular to a longitudinal axis of the sliding component in the unlocked position; and
the plane parallel to the orifice is not perpendicular to the longitudinal axis of the sliding component in the locked position.

7. The adjustable backrest of claim 1, wherein:
the bracing arm includes a cylindrical rod having a spring circumferentially positioned therearound;
the spring is operative to bias a lever selectively against an exterior of the cylindrical rod to inhibit sliding of the bracing arm with respect to the back support in the locked position; and
the latch includes a release mechanism in communication with the lever and operative to overcome the bias of the lever and enable repositioning of the bracing arm with respect to the back support in the unlocked position.

8. An adjustable backrest adapted for use with a collapsible stroller, the backrest comprising:
a backrest angularly repositionable with respect to a seat portion of a stroller;
a support arm laterally inset and mounted to a rear portion of the backrest, the support arm also mounted to a support structure of a stroller; and
a repositionable portion of the support arm being selectively engaged by a repositionable restraint operative to inhibit the backrest from being angularly repositioned with respect to the seat portion.

9. A method of repositioning a backrest of a collapsible stroller, the method comprising:
disengaging a restraint impeding angular adjustment of a backrest of a collapsible stroller, where the disengaging act may occur while the backrest is under a load and where the disengaging act may occur without substantially changing an angular orientation of the backrest.

10. A one-hand fold mechanism for a collapsible stroller comprising:
a trigger repositionably mounted to a handle of a stroller and in communication with a release operative to enable frame members of the stroller to collapse; and
a lock repositionable with respect to the trigger and operative to selectively inhibit movement of at least one of the trigger and the release in the locked position, where the locked position corresponds to an unfolded position of the frame members of the stroller.

11. The one-hand fold mechanism of claim 10, wherein:
the lock is spring biased in the locked position;
the trigger is pivotally repositionable with respect to the lock; and
the lock is pivotally repositionable with respect to the trigger.

12. The one-hand fold mechanism of claim 10, further comprising a reel, wherein:
connecting lines are mounted concurrently to the reel and the release; and
repositioning of the reel is operative to reposition the release.

13. The one-hand fold mechanism of claim 12, wherein:
the trigger is adapted to engage the reel; and
the lock is adapted to engage at least one of the trigger and reel to selectively inhibit repositioning of the reel.

14. The one-hand fold mechanism of claim 10, wherein:
the lock is adapted to be repositioned by a user's thumb;
the trigger is adapted to be repositioned by at least one of the user's fingers; and
the thumb and at least one of the user's fingers are on a single hand.

15. The one-hand fold mechanism of claim 10, wherein:
the lock is pivotally mounted to the handle of the stroller;
the trigger is pivotally mounted to the handle of the stroller;
the trigger includes a trigger camming surface adapted to interface a lever camming surface associated with a trigger lever, where pivotal contact between the camming surfaces is operative to displace the lever;
the release includes a connecting line; and
the connecting line is in communication with the lever so that movement of the lever is transformed into movement of the connecting line so that predetermined displacement of the lever is operative to enable frame members of the stroller to collapse.

16. A method of collapsing a children's stroller, the method comprising:
gripping a handle of a children's stroller utilizing a single hand;
repositioning a locking mechanism mounted to the handle of the children's stroller utilizing at least one finger or thumb of the single hand;
actuating a release mechanism associated with the stroller utilizing at least the other of one finger or thumb of the single hand;
where the actuating act enables the children's stroller to collapse in a compact state.

17. A napper bar for use with an infant stroller comprising:
a napper bar adapted to be mounted to a stroller frame and adapted to at least partially circumscribe a child positioned on the stroller, the napper bar including a removable tray that includes a male contour at least partially defining at least one cavity, the male contour of the removable tray adapted to be received within a corresponding female contour of the napper bar.

18. The napper bar of claim 17, further including recessed therein shaped to receive corresponding detents on the tray.

19. The napper bar of claim 18, wherein:
the tray includes at least one recess thereon, and the napper bar includes at least one depression corresponding therewith to facilitate removal of the tray from the napper bar.
